(19) United States
(12) Patent Application Publication
(10) Pub. No.: US 2026/0170164 A1
(43) Pub. Date: Jun. 18, 2026

(54) VEHICLE FOR CONTROLLING ACCESS TO RECORDS, METHOD FOR CONTROLLING ACCESS TO RECORDS OF VEHICLE, AND STORAGE MEDIUM

(71) Applicants: Hyundai Motor Company, Seoul (KR); Kia Corporation, Seoul (KR)

(72) Inventor: Seul A Jung, Hwaseong-si (KR)

(21) Appl. No.: 19/229,842

(22) Filed: Jun. 5, 2025

(30) Foreign Application Priority Data
Dec. 17, 2024 (KR) 10-2024-0188177

(51) Int. Cl. G06F 21/62; G07C 9/00

(52) U.S. Cl. CPC G06F 21/6218; G07C 9/00309

(57) ABSTRACT

A vehicle in which access to records is controlled includes: a record provider acquiring records of a vehicle and storing the records; and a vehicle controller controlling unlocking of the vehicle with a key, wherein the vehicle controller detects a device with which to access to the records, transmits information on a subject accessing records corresponding to the device or information on a subject unlocking a vehicle corresponding to the key to the exterior of the vehicle, and selectively authorize for access to at least a portion of the records upon receipt of an authorization signal for access to at least a portion of the records from the exterior of the vehicle.

### CROSS-REFERENCE TO RELATED APPLICATIONS

This application claims benefit of priority to Korean Patent Application No. 10-2024-0188177 filed on December 17, 2024, in the Korean Intellectual Property Office, the disclosure of which is incorporated herein by reference in its entirety.

### TECHNICAL FIELD

The present disclosure relates to a vehicle in which access to records is controlled, a method for controlling access to records of a vehicle, and a storage medium therefor.

### BACKGROUND

In general, a vehicle may include a device such as a black box for acquiring and storing records (e.g., image), where the stored records may be used as evidence in the event of an accident while the vehicle is driving, or may be used as data informing a vehicle owner of a situation around the vehicle while the vehicle is parked.

For example, a built-in camera installed in a vehicle can acquire records (e.g., images) while the vehicle is driving/parked, output the same in real time through a display device in the vehicle, and transmit the same to a server providing a Connected Car Service (CCS) network, and a vehicle owner can view the records through a smartphone app, or the like.

Recently, a key that a vehicle owner uses to lock and unlock the vehicle has also been gradually developed. As a key has developed, it has become increasingly free and frequent for a vehicle owner to lend/share a key to temporarily grant driving rights to others.

### SUMMARY

As vehicle owners more freely lend/share keys, the risk of unauthorized access to records of a vehicle by lenders or sharers of keys may be increased. Alternatively, regardless of the actual lending/sharing of the keys, passengers in the vehicle may have unauthorized access to the records of the vehicle.

A vehicle in which access to records is controlled, a method for controlling access to records of a vehicle, and a storage medium therefor according to an aspect of the present disclosure may prevent unauthorized access to records of a vehicle by a subject other than a vehicle owner.

According to an aspect of the present disclosure, a vehicle in which access to records is controlled includes: a record provider acquiring records of a vehicle and storing the records; and a vehicle controller controlling unlocking of the vehicle with a key, wherein the vehicle controller may detect a device with which to access the records, transmit information on a subject accessing records corresponding to the device or information on a subject unlocking a vehicle corresponding to the key to the exterior of the vehicle, and may selectively authorize for access to at least a portion of the records upon receipt of an authorization signal for access to at least a portion of the records from the exterior of the vehicle.

For example, the exterior of the vehicle may include a server or a vehicle owner terminal, and the vehicle controller may transmit the information on the subject accessing records and the information on the subject unlocking a vehicle to the server or the vehicle owner terminal.

For example, the information on the subject accessing records may include user information or device identification information of the device with which to access the records, and the information on the subject unlocking a vehicle may include user information of the key or key identification information.

For example, the exterior of the vehicle may include a server or a vehicle owner terminal, and access to the records may include access to the records via wired communication or short-range wireless communication.

For example, the vehicle controller may transmit the records to the server or the vehicle owner terminal, and receive an acknowledgement signal of records from the server or the vehicle owner terminal.

For example, the authorization signal for access to at least a portion of the records may include information on one-time authorization or information on permanent authorization.

For example, the record provider may set categories for records, and classify acquired records according to the set categories, and the vehicle controller may authorize for access limited to the records classified in a category corresponding to the authorization signal for access to at least a portion of the records.

For example, the record may include an image, the record provider may set a FLAG for each category, and additionally store a flag corresponding to an image acquired at a time when conditions corresponding to the set categories is satisfied, and the authorization signal for access to at least a portion of the records may include flag selection information.

For example, the conditions corresponding to the set categories may include at least one of: whether there is a passenger in a vehicle in an acquired image; whether the vehicle in the acquired image is driving or parked; whether a location of the vehicle in the acquired image is within or outside the set region; and whether a time of the acquired image is within or outside the set time range.

According to an embodiment of the present disclosure, a method for controlling access to records of a vehicle may include operations in which: a server receives information on a subject accessing records and information on a subject unlocking a vehicle, from a vehicle or in advance; the server transmits event information for access to a vehicle owner terminal when the information on the subject accessing records does not match the information on the subject unlocking a vehicle; and the server transmits an authorization signal for access to at least a portion of the records to the vehicle when receiving information on setting authorization for access to records from the vehicle owner terminal.

For example, the transmitting to the vehicle owner terminal may include transmitting an authorization signal for access to the records to the vehicle when the information on the subject accessing records matches the information on the subject unlocking a vehicle, the receiving may include receiving the information on the subject accessing records and the information on the subject unlocking a vehicle from the vehicle, the information on the subject accessing records may include user information a device with which to access the records of the vehicle or device identification information, and the information on the subject unlocking a vehicle may include user information of a key unlocking the vehicle or key identification information.

For example, the method for controlling access to records of a vehicle may further include an operation in which the server receives records from the vehicle, and transmits the records to the vehicle owner terminal according to a request of the vehicle owner terminal, wherein the records may include an image.

For example, the method for controlling access to records of a vehicle may further include operations in which: the server receives an acknowledgement signal of records from the vehicle owner terminal, and transmits the acknowledgement signal of records to the vehicle; and the server receives an acknowledgement signal of event information for access to records from the vehicle owner terminal and transmits the acknowledgement signal of event information for access to records to the vehicle.

According to an embodiment of the present disclosure, a method for controlling access to records of a vehicle may include operations in which: a vehicle owner terminal receives event information for access to records from a server or a vehicle; the vehicle owner terminal provides an interaction for selectively receiving information on authorization for access to at least a portion of records to a subject accessing records corresponding to the event information for access to records; and the vehicle owner terminal selectively transmits, based on the result of the interaction, information on setting authorization for access to records to the server or the vehicle.

For example, the event information for access to records may include information on a subject accessing records or information on a subject unlocking a vehicle, and the providing the interaction may include providing an interaction for outputting or receiving the information on the subject accessing records or the information on the subject unlocking a vehicle.

For example, the event information for access to records may include the information on the subject accessing records and the information on the subject unlocking a vehicle, and the providing the interaction may include providing an interaction for outputting or receiving information on whether the information on the subject accessing records matches the information on the subject unlocking a vehicle.

For example, the method for controlling records of a vehicle may further include an operation in which the vehicle owner terminal receives records from the server or vehicle, wherein the records may include an image.

For example, the operation of providing the interaction may include providing an interaction for selectively receiving a selection of categories for records, and providing an interaction for selectively receiving a selection of information on one-time authorization or information on permanent authorization, and the information on setting authorization for access to records may include information on authorization for access limited to records corresponding to the selected categories, and may include information on one-time authorization or information on permanent authorization.

A storage medium according to an embodiment of the present disclosure may record one or more programs including instructions for executing the method for controlling the records of a vehicle.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a drawing illustrating a vehicle in which access to records is controlled according to an embodiment of the present disclosure;

FIG. 2 is a drawing illustrating a vehicle in which access to records is controlled, a method for controlling access to records of a vehicle, and a storage medium therefor according to an embodiment of the present disclosure;

FIGS. 3 and 4 are flowcharts illustrating an operation of a vehicle in which access to records is controlled, a method for controlling access to records of a vehicle, and a storage medium therefor according to an embodiment of the present disclosure;

FIGS. 5 and 6 are flowcharts illustrating a flow of operations between a subject for access to records (e.g., an authorization sharer), a server, a vehicle owner terminal, and a vehicle (e.g., a build-in cam) according to an embodiment of the present disclosure;

FIG. 7 is a flow chart illustrating an operation regarding a category into which records are classified in an embodiment of the present disclosure.

FIG. 8 is a flow chart illustrating a category for records in an embodiment of the present disclosure; and

FIG. 9 is a flowchart illustrating transmission/reception of records and/or acknowledgements in an embodiment of the present disclosure.

### DETAILED DESCRIPTION OF ILLUSTRATIVE EMBODIMENTS

Because the present disclosure may have various changes and may have various exemplary embodiments of the present disclosure, specific embodiments may be illustrated in the drawings and described in detail. However, this is not intended to limit the present disclosure to specific embodiments, it should be understood to include all modifications, equivalents, and substitutes included in the spirit and technical scope of the present disclosure.

Terms such as first, second, and the like may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of the plurality of related listed items.

The terms used in the present application may be only used to describe specific embodiments, and are not intended to limit the present disclosure. The singular expression may include the plural expression, unless the context clearly dictates otherwise. In the present application, it should be understood that terms such as “include,” “comprise,” or “have” are intended to designate that features, numerals, steps, operations, components, parts, or combination thereof described in the specification exist, but one or more other features of this disclosure do not preclude the existence or addition of numbers, steps, operations, components, parts, or combinations thereof.

Unless defined otherwise, all terms used herein, including technical or scientific terms, have the same meaning as that which can commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal manner unless explicitly defined in the present application.

In the present specification, a vehicle (including an electric vehicle) refers to a variety of vehicles for moving an object to be transported, such as people, animals, or goods, from a starting point to a destination. These vehicles are not limited to vehicles that run on roads or tracks.

Hereinafter, preferred embodiments of the present disclosure will be described in more detail with reference to the accompanying drawings.

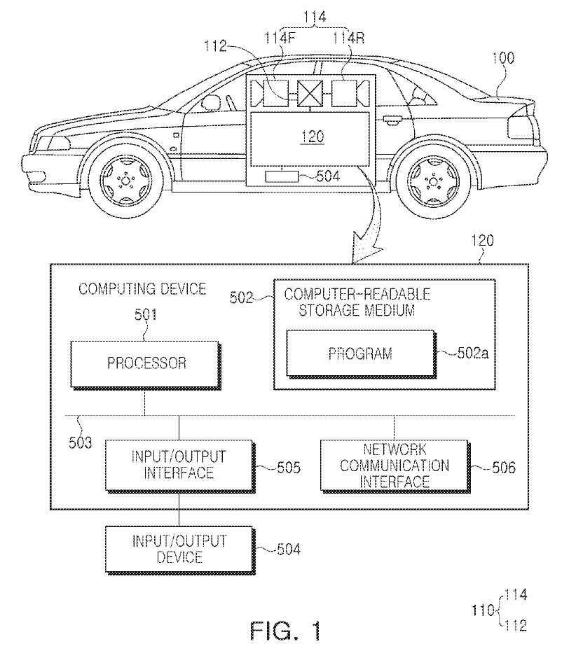

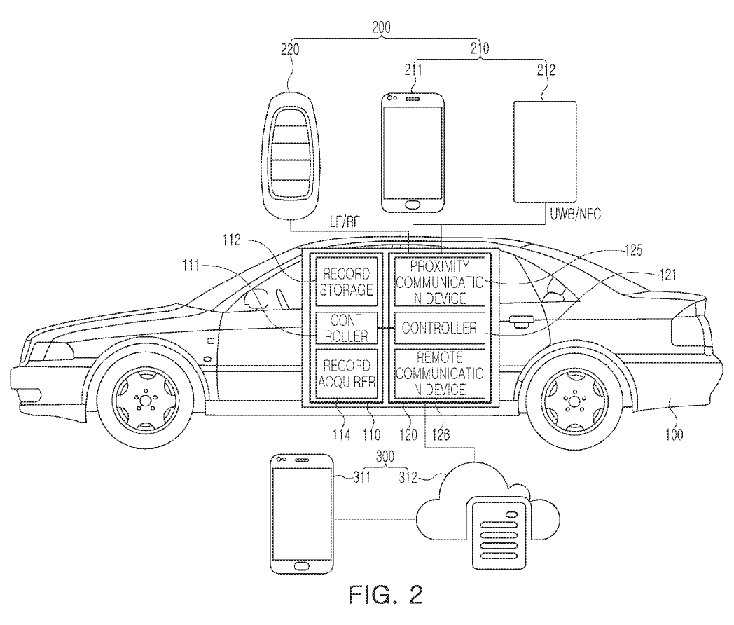

Referring to FIGS. 1 and 2, a vehicle 100 in which access to records is controlled according to an embodiment of the present disclosure may include a record provider 110 and a vehicle controller 120.

The record provider 110 may acquire records of the vehicle 100 and store the records. For example, the record provider 110 may include a record acquirer 114 acquiring records and a record storage 112 storing records. The record storage 112 may be implemented as a storage device such as memory or storage.

For example, the record provider 110 may acquire and store an image (video or image), and the record acquirer 114 may include a front camera 114F acquiring a front image of the vehicle 100 and/or a rear camera 114R acquiring a rear image of the vehicle 100. The records are not limited to images, and may include audio, or may include recorded data related to the images/audio (e.g., vehicle data when the images/audio were acquired). The record provider 110 may be defined as a built-in cam, and may be built into the vehicle 100 like a built-in black box, but an embodiment thereof is not limited thereto.

For example, the record provider 110 may include a controller 111 controlling communication (or executing communication interface operations) between the record provider 110 and the vehicle controller 120, and the controller 111 may communicate with the vehicle controller 120 so that the vehicle controller 120 may control the record storage 112 and/or the record acquirer 114.

The controller 111 and/or the vehicle controller 120 may be implemented as an information processing device for generating and processing new information by performing operations according to a preset program or function based on collected information. For example, the controller 111 and/or the vehicle controller 120 may include an electronic control unit (ECU) controlling various devices included in the vehicle 100. The ECU may be implemented as an ECU controlling an infotainment device (e.g., a display device, a navigation device, an around view monitoring device), and the like, and may also be implemented as an engine control unit, a transmission control unit, an engine management system electronic control unit (EMS ECU), a transmission management system electronic control unit (TMS ECU), an airbag control module (ACU), an anti-locking brake system electronic control unit (ABS ECU), an instrumentation and driver information module.

The vehicle controller 120 may include at least one of a controller 121, a proximity communication device 125, and a remote communication device 126. The proximity communication device 125 may include a structure (e.g., connector, antenna, communication circuit) supporting wired communication (Universal Serial Bus (USB) connection communication) or short-range wireless communication (e.g., Ultra-wideband (UWB), and Near Field Communication (NFC). The proximity communication device 125 may include Body Domain Control (BDC) logic.

The remote communication device 125 may include a structure (e.g., an antenna, a communication circuit) supporting long-range wireless communication (e.g., cellular communication). The controller 121 may control communication within the vehicle 100 (or execute communication interface operations) and may include a gateway or a Central Communication Unit (CCU). The remote communication device 126 may include a Data Communication Unit (DCU).

First, a vehicle driver may interact with a vehicle owner terminal 311, so that the vehicle owner terminal 311 may remotely communicate with the remote communication device 126 via a server 312. For example, the server 312 may be implemented as a server (including a cloud) providing a Connected Car Service (CCS) network, and the vehicle owner terminal 311 may be a portable terminal of which a communication target is not limited to a vehicle, such as a smartphone.

For example, the remote communication device 126 may transmit records to a server 312, and the vehicle owner terminal 311 may view the records stored in the server 312 after performing an authentication process. Even without an authentication process, the server 312 may identify the remote communication device 126 and the vehicle owner terminal 311, respectively (e.g., identification through identification number verification). The server 312 may prevent a subject other than the vehicle owner terminal 311 from accessing the records without prior approval from the vehicle owner terminal 311.

Second, the vehicle controller 120 may control unlocking of a vehicle 100 by a key 200. Unlocking of the vehicle 100 by the key 200 may be in accordance with the authentication process, so the vehicle owner may view the records of the record provider 110 through the proximity communication device 125 in the unlocked vehicle 100.

For example, the key 200 may include at least one of a digital key 210 and a smart key 220, and the digital key 210 may be included in a terminal 211 or a card 212. The terminal 211 may be a vehicle owner terminal 311 or another person's terminal. The vehicle owner terminal 311 may include the digital key 210, and may lend (and/or share) the digital key 210 to another person's terminal.

For example, the digital key 210 may be implemented as an intangible logic providing a user authentication procedure via short-range wireless communication (e.g., UWB, NFC), and the vehicle owner terminal 311 may communicate with another person's terminal and/or a server 312 to lend (and/or share) the digital key 210. For example, the smart key 220 may be implemented as a terminal specialized for unlocking the vehicle 100 via short-range wireless communication (e.g., low frequency (LF) communication or radio frequency (RF) communication).

The vehicle owner may lend (and/or share) the key 200 to another person (e.g., a vehicle owner's family member, coworker, and the like) to allow the another person to drive the vehicle 100 and travel. However, the vehicle owner may want the another person to drive the vehicle but not have unauthorized access to the records of the record provider 110. In addition, the vehicle owner may allow the another person to ride in the vehicle 100 while driving the vehicle 100. In this case, the vehicle owner may want to prevent the passenger of the vehicle 100 from accessing the records of the record provider 110 without authorization.

The vehicle controller 120 may detect a device with which to access records of the record provider 110 and transmit information on a subject accessing records corresponding to the device and/or information on a subject unlocking a vehicle corresponding to the key 200 to the exterior 300 of the vehicle, and selectively authorize for access to at least a portion of the records upon receipt of an authorization signal for access to at least a portion of the records from the exterior 300 of the vehicle.

For example, when a vehicle owner lends (and/or shares) a digital key 210 to another person, a subject unlocking a vehicle corresponding to the digital key 200 may be a vehicle owner. When the another person or passenger in a vehicle accesses the records, the subject accessing records may be the another person or the passenger in a vehicle. That is, depending on whether the digital key 210 is lent (and/or shared) or whether there is a passenger, a matching relationship between the vehicle unlocking a subject and the subject accessing records may vary. Therefore, the exterior 300 of the vehicle may determine whether to have access to at least a portion of the record based on the information on the subject accessing records and/or the information on the subject unlocking a vehicle, and the vehicle 100 may receive an authorization signal for access according to the determination.

Accordingly, the vehicle owner can prevent the lender (and/or sharer) of the key 200 or the passengers in the vehicle 100 from unauthorized access to the records of the record provider 110. The access to the records may include access to the records via wired communication or short-range wireless communication.

For example, the exterior 300 of the vehicle may include a server 312 and/or a vehicle owner terminal 311, and the vehicle controller 120 may transmit information on a subject accessing records and/or information on a subject unlocking a vehicle to the server 312 and/or the vehicle owner terminal 311. The information on the subject accessing records may include user information of a device with which to access records and/or device identification information, and information on the subject unlocking a vehicle may include user information of a key 200 and/or key identification information.

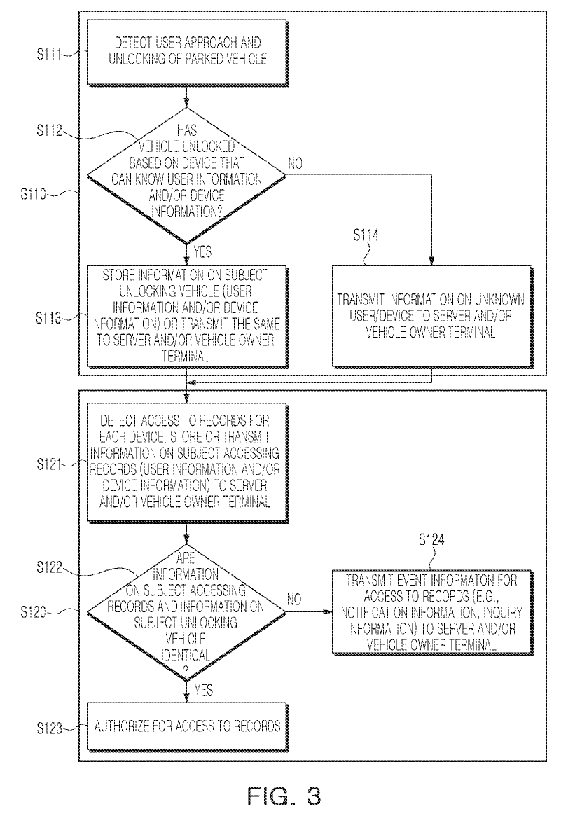

Referring to FIGS. 2 and 3, the vehicle controller 120 of the vehicle 100 may execute an operation of unlocking a vehicle (S110) and an operation of controlling access to records (S120).

In the operation of unlocking a vehicle (S110), the vehicle 120 may detect (S111) that a user approaches a parked vehicle 100 and unlocks the vehicle 100, and may check (S112) whether the vehicle is unlocked based on a device (e.g., a key 200) that can know user information and/or device information (e.g., key information). When a subject unlocking a vehicle is confirmed, the subject unlocking a vehicle (user information and/or device information) may be stored (or temporarily stored) or transmitted (S113) to a server 312 and/or a vehicle owner terminal 311.

In the operation of controlling access to records (S120), the vehicle controller 120 may detect access to a device of records, and store (or temporarily store) information on a subject accessing records (user information and/or device information) or transmit (S121) the same to a server 312 and/or a vehicle owner terminal 311.

The vehicle owner terminal 311 may receive information on a subject accessing records and/or information on a subject unlocking a vehicle, or receive information related thereto (e.g., event information for access to records) from the server 312. Thereafter, the vehicle owner terminal 311 may output (e.g., display) information on a subject accessing records and/or information on a subject unlocking a vehicle, or information related thereto (e.g., event information for access to records), and a vehicle owner may determine whether to authorize for access to at least a portion of the records to a subject accessing records based on the output information, and input the determination information into the vehicle owner terminal 311.

For example, the vehicle owner may input information into the vehicle owner terminal 311 to determine whether to authorize for access to records based on whether the information on a subject accessing records and the information on a subject unlocking a vehicle are identical (S122). According to the design, the vehicle owner terminal 311 and/or server 312 may verify whether the information on the subject accessing records and the information on the subject unlocking a vehicle are identical (S122) instead of the vehicle owner, and automatically control whether to authorize for access to the records based on the verification result.

In the record access control operation (S120), the vehicle controller 120 may authorize for access to records (S123) when the information on the subject accessing records and the information on the subject unlocking a vehicle are identical (S122), and otherwise, event information for access to records (e.g., notification information, inquiry information) may be transmitted (S124) to the server 312 and/or the vehicle owner terminal 311.

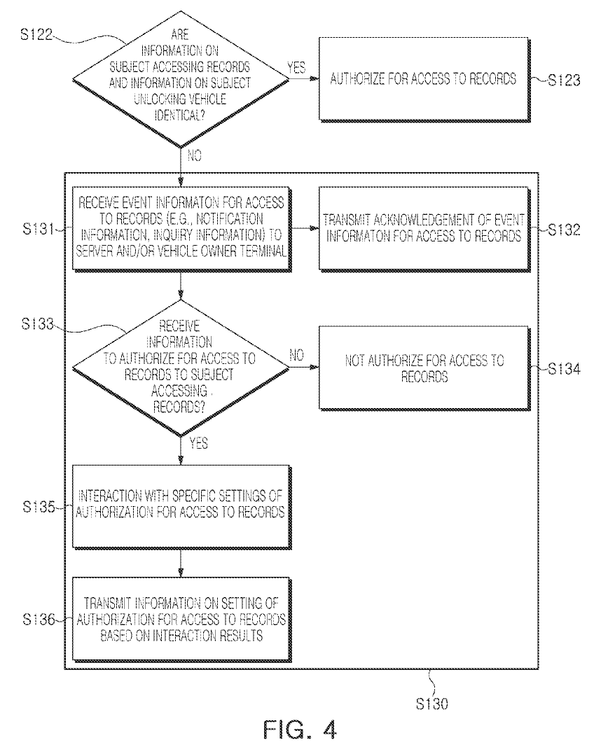

Referring to FIGS. 2, 3 and 4, a method for controlling access to records of a vehicle according to an embodiment of the present disclosure may include an operation (corresponding to S114 and/or S121 of FIG. 3) in which a server 312 provides (e.g., receives in advance) or receives (e.g., receives in real time) information on a subject accessing records and information on a subject unlocking a vehicle from a vehicle, an operation (corresponding to S124 of FIG. 3) in which a server 312 transmits event information for access to records (e.g., notification information, inquiry information) to a vehicle owner terminal 311 when the information on the subject accessing records does not match the information on the subject unlocking a vehicle , and an operation (corresponding to S136 of FIG. 4) in which a server 312 transmits an authorization signal for access to at least a portion of the records to the vehicle 100 when receiving information on setting authorization for access to the records from the vehicle owner terminal 311.

The vehicle owner terminal 311 may output (e.g., display) event information (e.g., notification information, inquiry information), and a vehicle owner may determine whether to authorize for access to records based on the event information, and input the determination information into the vehicle owner terminal 311. For example, the notification information may be event information (event information increasing a degree of freedom of a vehicle owner to determine whether to authorize) which is transmitted regardless of whether there is a match between the information on the subject accessing records and the information on the subject unlocking a vehicle, and the inquiry information may be event information (event information that improves the convenience of determining whether to authorize to the vehicle owner) whether transmission occurs may vary depending on whether there is a match between the information on the subject accessing records and the information on the subject unlocking a vehicle.

For example, the operation of transmitting to the vehicle owner terminal may include transmitting an authorization signal for access to the record to the vehicle 100 when the information on the subject accessing records matches the information on the subject unlocking a vehicle (corresponding to S123 of FIG. 4). The server 312 may omit an operation (corresponding to S124 of FIG. 3) of transmitting event information for access to records (e.g., notification information, inquiry information) to the vehicle owner terminal 311 when the information on the subject accessing records matches the information on the subject unlocking a vehicle. Accordingly, the vehicle owner terminal 311 may not receive unnecessary event information for access to records when the vehicle owner accesses the record, so that the vehicle owner can access the record more efficiently.

Referring to FIGS. 2 and 4, a method for controlling access to records of a vehicle according to an embodiment of the present disclosure may include an operation (S131) in which a vehicle owner terminal 311 receives event information for access to records from a server 312 or a vehicle 100, and operations (S133 and S135) in which a vehicle owner terminal 311 provides an interaction (can include an authentication procedure) to selectively receive information on authorization for access to at least a portion of the records to the subject accessing the record corresponding to the event information accessing the event information for access to records. The vehicle owner terminal 311 may selectively include operation of transmitting (S136) information on setting authorization for access to records to the server 312 or vehicle 100 or not authorizing (S134) for access to records depending on the result of the interaction. Accordingly, the vehicle owner can prevent the lender (and/or sharer) of the key 200 or the passengers in the vehicle 100 from unauthorized access to the records of the record provider 110.

The server 312 may receive an acknowledgement signal of event information for access to records from the vehicle owner terminal 311 (S132), and transmit the acknowledgement signal of event information for access to records to the vehicle 100.

The event information for access to records may include information on a subject accessing records and/or information on a subject unlocking a vehicle. For example, the operation of providing the interaction (S133) may include providing an interaction for outputting or receiving the information on the subject accessing records and/or information on the subject unlocking a vehicle, or may include providing an interaction for outputting or receiving information on whether the information on the subject accessing records matches the information on the subject unlocking a vehicle.

The operation of providing the interaction (S135) may include providing an interaction for selectively receiving a selection of categories for records, and providing an interaction for selectively receiving a selection of information on one-time authorization and/or information on permanent authorization. The information on setting authorization for access to records (and/or authorization signal for access) may include the information on authorization for access limited to the records corresponding to the selected category, and may include information on one-time authorization and/or information on permanent authorization.

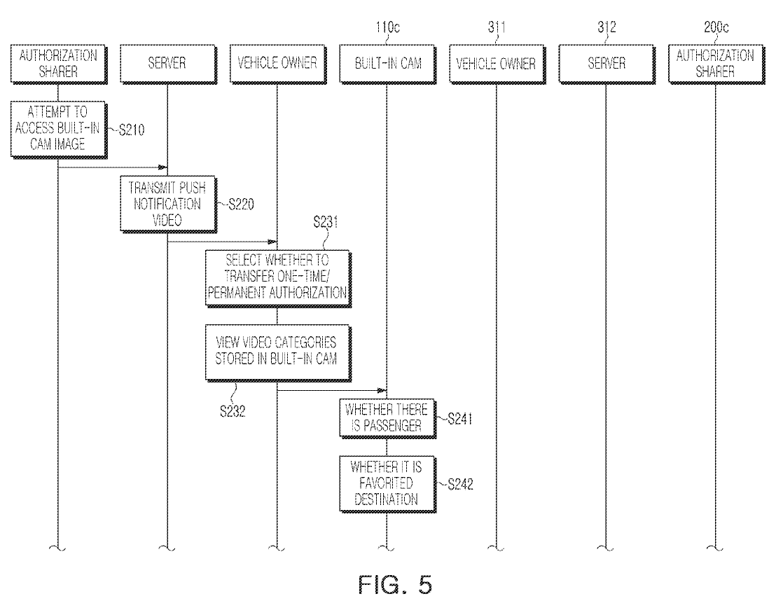

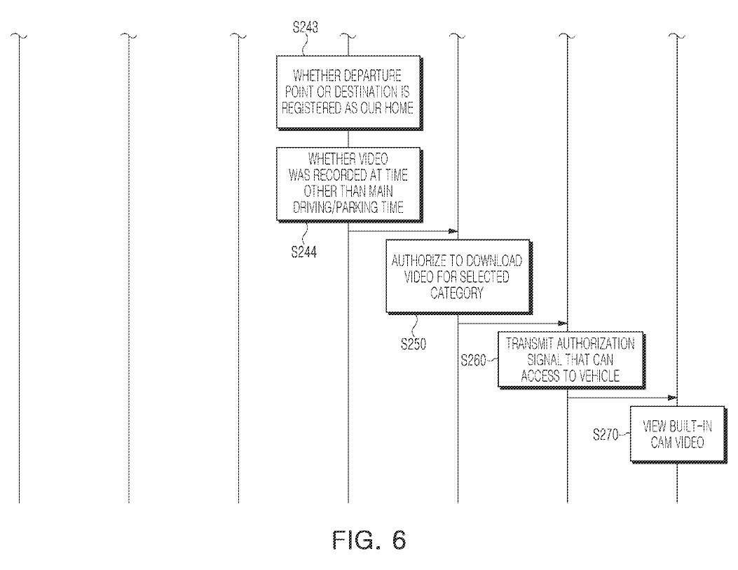

Referring to FIGS. 2, 5, and 6, an authorization sharer 200c may attempt to access (S210) a record (e.g., built-in cam video) of a record provider 110, and a vehicle 100 may transmit information on a subject accessing records and/or vehicle unlocking subject information to a server 312.

Thereafter, the server 312 may transmit event information for access to records (e.g., PUSH notification video) to the vehicle owner terminal 311 (S220). The event information for access to records may include information on a subject accessing records and/or information on a subject unlocking of a vehicle, or may include inquiry information related thereto (e.g., inquiry information based on whether information on a subject matches).

Accordingly, the vehicle owner can be notified through a vehicle owner terminal 311 that an authorization sharer 200c is attempting to access records (e.g., built-in cam images) through the vehicle owner terminal 311, and may identify the authorization sharer 200c. Therefore, the vehicle owner may determine whether to authorize for access to records depending on who the authorization sharer 200c is. In addition, the vehicle owner terminal 311 may interact with a vehicle owner to select whether to transfer one-time/permanent authorization (S231), and request a category search(S232) for category selection for records (e.g., built-in cam images).

For example, a category set in the built-in cam 110c may include whether there is a passenger (S241), whether it is a favorite destination (S242), whether a departure point or destination is registered as our home (S243), and whether a video was recorded at a time other than a main driving/parking time (S244).

The vehicle owner terminal 311 may transmit information on setting authorization for access to records to the server 312 to interact with the vehicle owner and authorize to download videos for the selected category (S250).

Thereafter, the server 312 may transmit (S260) an authorization signal that can access the vehicle 100 according to the information on setting authorization for access to records, and the authorization sharer 200c may view (S270) records (e.g., built-in cam video) for the selected category.

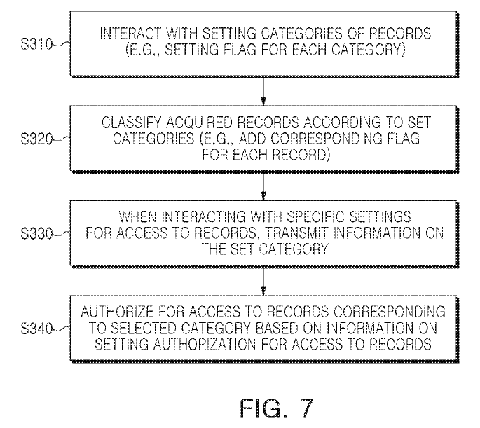

Referring to FIGS. 2 and 7, the record provider 110 may set a category for the record (S310), and classify the acquired record according to the set category (S320). When interacting with specific settings for authorization of access to records, the vehicle owner terminal 311 may transmit the set category to the server 312 and/or vehicle 100 (S330). The vehicle controller 120 may grant authorization for access (S340) limited to records classified in a category corresponding to an authorization signal for access to at least a portion of the records.

For example, the record provider 110 may set a flag (FLAG) for each category, additionally store a flag corresponding to an image acquired at a time when conditions corresponding to the set category is satisfied, and an authorization signal for access to at least a portion of the record may include flag selection information.

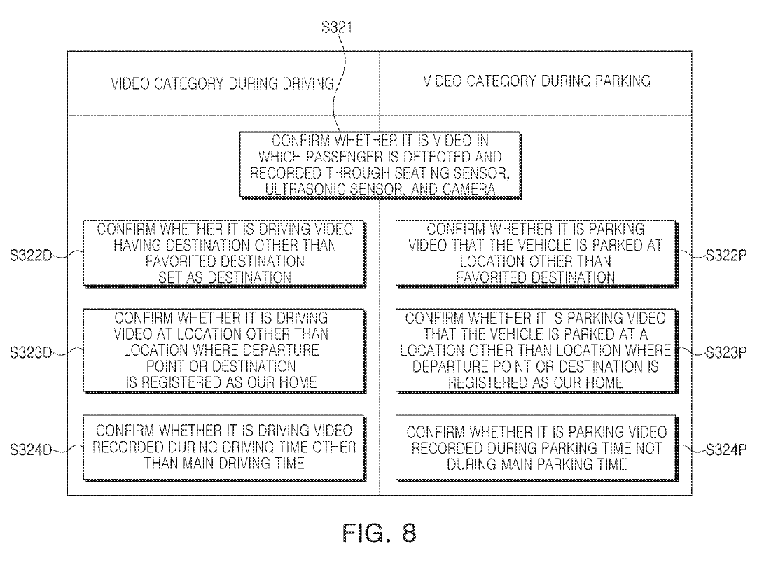

Referring to FIGS. 2 and 8, the conditions corresponding to the set categories may include whether there is a passenger in a vehicle in an acquired image (S321), and whether the vehicle in the acquired image is driving (S322D, S323D, S324D) or parked (S322P, S323P, S324P), whether a location of the vehicle in the acquired image may include whether it is within or outside a set region (e.g., a favorited destination, our home) (S322D, S323D, S322P, S323P), and whether a time of the acquired image is within or outside the set time range (S324D, S324P).

For example, the vehicle controller 120 may transmit data of at least one of a seating sensor, an ultrasonic sensor, a camera, a global positioning system (GPS) sensor, a timer, and a light sensor within the vehicle 100 to the record provider 110, and the record acquirer 114 of the record provider 110 may constantly acquire front and/or rear images, and the controller 111 of the record provider 110 may select an image to be stored in the record storage 112 among the acquired images of the record acquirer 114 based on the data. In this case, the record provider 110 may set a flag (FLAG) for each category for the record.

For example, the flag (FLAG) of the category corresponding to a parking video recorded during a parking time other than the main parking time may be 4P, and the data of the video may include 4P flag. When a vehicle owner wishes to authorize for access limited to the category, the vehicle owner terminal 311 may include the 4P flag in the information on setting authorization for access to records to be transmitted, and the vehicle controller 120 may authorize for access limited to records that include the 4P flag data among the records of the record provider 110.

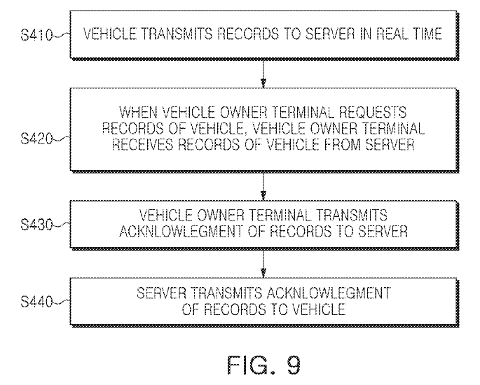

Referring to FIGS. 2 and 9, the vehicle controller 120 may transmit (S410 and S420) records of a record provider 110 to a server 312 or a vehicle owner terminal 311, and receive (S430 and S440) an acknowledgement signal of records from the server 312 or the vehicle owner terminal 311.

Alternatively, the server 312 may execute an operation of receiving (S410) a record from a vehicle 100, and transmitting (S420) the record to the vehicle owner terminal 311 according to a request from the vehicle owner terminal 311. The vehicle owner terminal 311 may execute an operation of receiving (S420) a record from the server 312 or the vehicle 100.

The server 312 may execute an operation of receiving an acknowledgement signal of records from the vehicle owner terminal 311 (S430), and an operation of transmitting the acknowledgement signal of records to the vehicle 100 (S440).

Meanwhile, referring to FIG. 1, a vehicle controller 120 may include a computing device having a processor 501 and a storage medium 502 recording one or more programs 502a configured to be executable by the processor 501, and the one or more programs 502a may include commands for executing the method for diagnostic communication in a vehicle according to an embodiment of the present disclosure.

In addition to the vehicle controller 120, the server 312 and/or the vehicle owner terminal 311 of FIG. 2 may also include the computing device. The computing device and the storage medium 502 included therein may include one or more programs including commands for executing a method for controlling access to records of a vehicle according to an embodiment of the present disclosure.

The computing device may include at least one processor 501, a computer-readable storage medium 502, and a communication bus 503. The communication bus 503 may interconnect various other components of the computing device 500, including the processor 501 and the computer-readable storage medium 502. For example, the computing device may be implemented as a microcontroller.

The processor 501 may cause the computing device to operate according to the above-described exemplary embodiments. For example, the processor 501 may execute one or more programs stored in the computer-readable storage medium 502. The one or more programs may include one or more computer executable instructions, wherein, when executed by the processor 501, the computer-readable executable instructions may be configured to cause the computing device to perform operations according to an exemplary embodiment.

The computer-readable storage medium 502 may be configured to store computer-executable instructions or program code, program data, and/or other suitable forms of information. A program 502a stored on the computer-readable storage medium 502 includes a set of instructions executable by the processor 501. In an embodiment, the computer-readable storage medium 502 may include a memory (a volatile memory such as a random-access memory, a non-volatile memory, or a suitable combination thereof), one or more magnetic disk storage devices, optical disk storage devices, flash memory devices, other forms of storage media that can be accessed by the computing device and store desired information, or suitable combinations thereof.

The computing device may also include one or more input/output interfaces 505 and one or more network communication interfaces 506 providing an interface for one or more input/output devices 504. The input/output interface 505 and the network communication interface 506 are connected to the communication bus 503. The network may be one of a cellular network, such as a global system for mobile communications (GSM), enhanced data rates for GSM evolution (EDGE), a general packet radio service (GPRS), a code division multiple access (CDMA), a time division CDMA(TD-CDMA), a universal mobile telecommunications system (UMTS), a long term evolution (LTE), or another cellular network.

The input/output device 504 may be connected to other components of the computing device through the input/output interface 505. The exemplary input/output device 504 may include an input device such as a pointing device (a mouse, a trackpad, or the like), a keyboard, a touch input device (a touchpad, a touchscreen, or the like), a voice or sound input device, various types of sensor devices, and/or an imaging device, and an output device such as a display device, a printer, a speaker, and/or a network card. The exemplary input/output device 504 may be included inside the computing device as a component constituting the computing device, or may be connected to the computing device as a separate device, distinct from the computing device.

Meanwhile, embodiments of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium such as hard disks, floppy disks and magnetic tapes, an optical recording medium such as CD-ROMs and DVDs, and program instructions such as ROM, RAM, and a flash memory and perform the same. Examples of the program may include not only machine language codes generated by a compiler, but also high-level language codes that may be executed by a computer using an interpreter.

As set forth above, according to an embodiment of the present disclosure, a vehicle in which access to records is controlled, a method for controlling access to records of a vehicle, and a storage medium therefor according to an aspect of the present disclosure may prevent unauthorized access to records of a vehicle by a subject other than a vehicle owner.

Accordingly, since a vehicle owner can reduce the risk of unauthorized access to records of a vehicle by a lender or sharer of a key or a passenger in the vehicle may be reduced, the vehicle owner can lend/share keys more freely and have more passengers in the vehicle. Therefore, the vehicle can be used more efficiently.

The present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes would be obvious to those of ordinary skill in the art.

What is claimed is:

1. A vehicle in which access to records is controlled, comprising:
a record provider acquiring records of the vehicle and storing the records; and
a vehicle controller controlling unlocking of the vehicle with a key,
wherein the vehicle controller:
detects a device with which to access the records,
transmits information on a subject accessing records corresponding to the device or information on a subject unlocking the vehicle corresponding to the key to an exterior of the vehicle, and
selectively authorizes access to at least a portion of the records upon receipt of an authorization signal for access to at least a portion of the records from the exterior of the vehicle.

2. The vehicle in which access to records is controlled of claim 1, wherein the exterior of the vehicle includes a server or a vehicle owner terminal, and
the vehicle controller transmits the information on the subject accessing records and the information on the subject unlocking the vehicle to the server or the vehicle owner terminal.

3. The vehicle in which access to records is controlled of claim 2, wherein:
the information on the subject accessing records includes user information of the device with which to access the records or device identification information, and
the information on the subject unlocking the vehicle includes user information of the key or key identification information.

4. The vehicle in which access to records is controlled of claim 1, wherein:
the exterior of the vehicle includes a server or a vehicle owner terminal, and
access to the records includes access to the records via wired communication or short-range wireless communication.

5. The vehicle in which access to records is controlled of claim 4, wherein the vehicle controller:
transmits the records to the server or the vehicle owner terminal, and
receives an acknowledgement signal of records from the server or the vehicle owner terminal.

6. The vehicle in which access to records is controlled of claim 1, wherein the authorization signal for access to at least a portion of the records includes information on one-time authorization or information on permanent authorization.

7. The vehicle in which access to records is controlled of claim 1, wherein:
the record provider:
sets categories for records, and
classifies acquired records according to the set categories, and
the vehicle controller authorizes for access limited to records classified in a category corresponding to the authorization signal for access to at least a portion of the records.

8. The vehicle in which access to records is controlled of claim 7, wherein:
the records include an image,
the record provider sets a flag for each category, and additionally stores a flag corresponding to the image acquired at a time when conditions corresponding to the set categories are satisfied, and
the authorization signal for access to at least a portion of the records includes flag selection information.

9. The vehicle in which access to records is controlled of claim 8, wherein the conditions corresponding to the set categories include at least one of:
whether there is a passenger in the vehicle in an acquired image;
whether the vehicle in the acquired image is driving or parked;
whether a location of the vehicle in the acquired image is within or outside a set region; and
whether a time of the acquired image is within or outside a set time range.

10. A method for controlling access to records of a vehicle, comprising:
receiving by a server, information on a subject accessing records and information on a subject unlocking the vehicle, from the vehicle or in advance;
transmitting, by the server, event information for access to records to a vehicle owner terminal when the information on the subject accessing records does not match the information on the subject unlocking the vehicle; and
transmitting, by the server, an authorization signal for access to at least a portion of the records to the vehicle when the server receives information on setting authorization for access to records from the vehicle owner terminal.

11. The method for controlling access to records of the vehicle of claim 10, wherein:
transmitting to the vehicle owner terminal comprises transmitting the authorization signal for access to the records to the vehicle when the information on the subject accessing records matches the information on the subject unlocking the vehicle,
receiving the information comprises receiving the information on the subject accessing the records and the information on the subject unlocking the vehicle from the vehicle,
the information on the subject accessing records includes user information of a device with which to access the records of the vehicle or device identification information, and
the information on the subject unlocking the vehicle includes user information of a key unlocking the vehicle or key identification information.

12. The method for controlling access to records of the vehicle of claim 10, further comprising:
receiving, by the server, records from the vehicle; and
transmitting the records to the vehicle owner terminal according to a request from the vehicle owner terminal,
wherein the records include an image.

13. The method for controlling access to records of the vehicle of claim 12, further comprising:
receiving, by the server, an acknowledgement signal of records from the vehicle owner terminal; and
transmitting the acknowledgement signal of records to the vehicle;
receiving, by the server, an acknowledgement signal of event information for access to records from the vehicle owner terminal; and
transmitting the acknowledgement signal of event information for access to records to the vehicle.

14. A method for controlling access to records of a vehicle, comprising:
receiving, by a vehicle owner terminal, event information for access to records from a server or vehicle;
providing, by the vehicle owner terminal, an interaction for selectively receiving information on authorization for access to at least a portion of records to a subject accessing records corresponding to the event information for access to records; and
selectively transmitting, by the vehicle owner terminal and based on a result of the interaction, information on setting authorization for access to records to the server or the vehicle.

15. The method for controlling access to records of the vehicle of claim 14, wherein:
the event information for access to records includes information on a subject accessing records or information on a subject unlocking the vehicle, and
providing the interaction includes providing the interaction for outputting or receiving the information on the subject accessing records or the information on the subject unlocking the vehicle.

16. The method for controlling access to records of the vehicle of claim 15, wherein:
the event information for access to records includes the information on the subject accessing records and the information on the subject unlocking the vehicle, and
providing the interaction includes providing the interaction for outputting or receiving information on whether the information on the subject accessing records matches the information on the subject unlocking the vehicle.

17. The method for controlling access to records of the vehicle of claim 14, further comprising:
receiving, by the vehicle owner terminal, records from the server or the vehicle,
wherein the records include an image.

18. The method for controlling access to records of the vehicle of claim 17, wherein:
providing the interaction comprises:
providing an interaction for selectively receiving a selection of categories for records; and
providing an interaction for selectively receiving a selection of information on one-time authorization or information on permanent authorization, and
the information on setting authorization for access to the records includes information on authorization for access limited to records corresponding to the selected category, and includes information on one-time authorization or information on permanent authorization.

19. A storage medium having recorded thereon one or more programs including instructions for executing the method for controlling access to records of the vehicle of claim 10.

20. A storage medium having recorded thereon one or more programs including instructions for executing the method for controlling access to records of the vehicle of claim 14.
